(19) United States
(12) Patent Application Publication
(10) Pub. No.: US 2019/0270279 A1
(43) Pub. Date: Sep. 5, 2019

(54) DECORATIVE METAL COMPONENT AND PROCESSING METHOD THEREFOR

(71) Applicant: Panasonic Intellectual Property Management Co., Ltd., Osaka (JP)

(72) Inventors: YUNAN O, Osaka (JP); HIDEO MINE, Nara (JP); YUKI MITA, Nara (JP); YOSHINOBU SAKAIDA, Osaka (JP); HIDEAKI NAKAGAWA, Osaka (JP)

(21) Appl. No.: 16/274,172

(22) Filed: Feb. 12, 2019

(30) Foreign Application Priority Data
Mar. 1, 2018 (JP) 2018-036071

(51) Int. Cl. B32B 15/08; B32B 7/023; B32B 7/12; B32B 3/28; B32B 37/18

(52) U.S. Cl. CPC B32B 15/08; B32B 7/023; B32B 7/12; B32B 2451/00; B32B 37/182; B32B 2307/412; B32B 3/28

(57) ABSTRACT

A decorative metal component with a high design property on a surface of a metal sheet is a formed article formed by press working such as bending or drawing operation with respect to a metal sheet, which includes a resin layer with concave and convex shapes laminated on one surface of the metal sheet, in which the resin layer has a light transmission property, the resin layer is formed of a surface layer and an intermediate layer for bonding the metal sheet to the surface layer, the intermediate layer is a thermoplastic resin, and when a distance in a vertical direction between a top of a convex ridge and a bottom surface of a concave trough adjacent in the concave and convex shape is “t1”, and the total thickness of the resin layer is “t0”, t0×0.13≤t1<t0×0.85.

### TECHNICAL FIELD

The technical field relates to a decorative metal component formed by press working such as a bending or drawing operation a laminated material provided with a resin layer having concaves and convexes on a surface of a metal sheet.

### BACKGROUND

Some household electric appliances such as a refrigerator, a washing machine, a dryer, a rice cooker, an air conditioner and a microwave, have a sheet-metal pressed article in external appearances. Specifically, efforts in which a design property originally possessed by metal is utilized by using, for example, a stainless hairline material having a hairline pattern on the surface of the metal sheet to thereby differentiate the design of a product and increase an added value are becoming active.

On the other hand, efforts for further improving the design property are required. FIG. 6 shows a production method for a metal can described in JP-A-H8-39729 (Patent Literature 1). This is the production method which can impart special decorativeness with a three-dimensional feel and a depth to an outer surface of a can body part, in which a film 103 is bonded to a surface of a sheet metal 101 through a thermosetting adhesive 102 and further adding concaves and convexes over the surface by roll transfer of a concave-convex shape 104 at the same time.

Though the improvement of design property is achieved by adding the concave-convex shape 104 in the related-art method shown in FIG. 6, it is difficult to make use of glossy feeling and surface treatment texture originally possessed by the metal sheet of the sheet metal 101 in the design property.

As the thermosetting adhesive 102 is used, it is possible to follow the concaves and convexes in rounding processing for producing the can after adding the concaves and convexes, however, it is difficult to follow them in processing in which large elongation is generated such as in drawing operation, and the concave and convex shapes added before performing the processing with the generation of large elongation collapse, which makes holding of the design property on appearance difficult.

### SUMMARY

An object of the present disclosure is to provide a decorative metal component with a high design property formed without causing collapse in shape such as reduction of a thickness in concave and convex parts in press working such as bending or drawing operation and is capable of visually recognizing gloss, hairlines, treatment texture such as vibration polishing in the metal sheet as well as generating depth feeling due to the concave and convex portions.

A decorative metal component according to the present disclosure is a formed article formed by press working such as a bending or drawing operation with respect to a metal sheet, which includes a resin layer with concave and convex shapes laminated on one surface of the metal sheet, in which the resin layer has a light transmission property, the resin layer is formed of a surface layer and an intermediate layer for bonding the metal sheet to the surface layer, the intermediate layer is a thermoplastic resin, and when a distance in a vertical direction between a top of a convex ridge and a bottom surface of a concave trough adjacent in the concave and convex shape is “t1”, and the total thickness of the resin layer is “t0”,

t0×0.13≤t1<t0×0.85.

Also in the decorative metal component, it is preferable that an external shape has a top surface part, a side surface part and a corner part connecting between the top surface part and the side surface part, and when a thickness from the surface of the metal sheet to the bottom surface of the trough of the concave and convex shape in the intermediate layer in the top surface part is Ht, a thickness from the surface of the metal sheet to the bottom surface of the trough of the concave and convex shape in the intermediate layer in the side surface part is Hs, and a thickness from the surface of the metal sheet to the bottom surface of the trough of the concave and convex shape in the intermediate layer in the corner part is Hc, the thicknesses have a relation of Ht>Hs>Hc.

Furthermore, in the decorative metal component, it is preferable that a light absorbing material is contained in a part of layers of the resin layer, the light absorbing material has a light transmission property, and in a first region and a second region adjacent to each other in the light absorbing material layer, the first region has a higher light absorption coefficient and a lower light transmittance than the second region.

A processing method for a decorative metal component according to the present disclosure is used when pressing a material including a resin layer with concave and convex shapes laminated on one surface of the metal sheet, in which the resin layer has a light transmission property, the resin layer is formed of a surface layer and an intermediate layer for bonding the metal sheet to the surface layer, the intermediate layer is a thermoplastic resin, and when a distance in a vertical direction between a top of a convex ridge and a bottom surface of a concave trough adjacent in the concave and convex shape is “t1”, and the total thickness of the resin layer is “t0”, t0×0.13≤t1<t0×0.85. The method includes the step of heating a part from the surface of the metal sheet to the bottom surface of the trough of the concave and convex shape to be higher than a softening temperature of the intermediate layer before press working to thereby allow the part from the surface of the metal sheet to the bottom surface of the trough in the concave and convex in the intermediate layer to follow an elongation of the metal sheet.

According to the above structure, the resin layer having the light transmission property with minute concave and convex shapes on the outer surface in which part thereof is the thermoplastic resin is formed on the metal sheet, therefore, it is possible to obtain the decorative metal component with high design property in which gloss, hairlines and treatment texture such as vibration polishing of the metal sheet can be visually recognized, and further, the depth feeling is generated due to minute concave and convex shapes.

As the resin layer part of which is the thermoplastic resin is used, the thickness in a layer part from the surface of the metal sheet to the top of the trough in the minute concave and convex shape is changed so as to correspond to each drawing shape, thereby obtaining the decorative metal component while keeping the minute concave and convex shapes without causing breakage.

### BRIEF DESCRIPTION OF THE DRAWINGS

FIG. 1A is a side cross-sectional view of a decorative metal component formed by press working and FIG. 1B is an enlarged cross-sectional view of a top surface part thereof according to Embodiment 1 of the present disclosure;

FIG. 2A is a side cross-sectional view of the decorative metal component formed by press working, FIG. 2B is an enlarged cross-sectional view of the top surface part thereof, FIG. 2C is an enlarged cross-sectional view of a side surface part thereof and FIG. 2D is an enlarged cross-sectional view of a corner part thereof according to Embodiment 2 of the present disclosure;

FIG. 3A is and enlarged cross-sectional view of the decorative metal component and FIG. 3B is an enlarged cross-sectional view of the decorative metal component of another specific example according to Embodiment 3 of the present disclosure;

FIG. 4 is a taken image on the surface of the decorative metal component thereof according to Embodiment 3 of the present disclosure. (a) of FIG. 4 is a taken image on the surface of the decorative metal component and (b) of FIG. 4 is an enlarged view thereof according to the same embodiment;

FIG. 5 is an enlarged cross-sectional view in the middle of bending operation of the corner part by press working according to Embodiment 4 of the present disclosure; and

FIG. 6 is a cross-sectional view in a process of giving a concave and convex shape described in Patent Literature 1.

### DESCRIPTION OF EMBODIMENTS

Hereinafter, respective embodiments of the present disclosure will be explained with reference to the drawings.

In the respective embodiments, the same symbols are given to the same components to be explained. The drawings are schematically shown mainly with respective components for making the components easy to understand. The thickness, length and so on of the shown respective components differ from actual dimensions for convenience of creating drawings.

The shape and so on of respective components are examples and are not particularly limited, which can be variously changed within a scope not substantially departing from advantages of the present disclosure.

### Embodiment 1

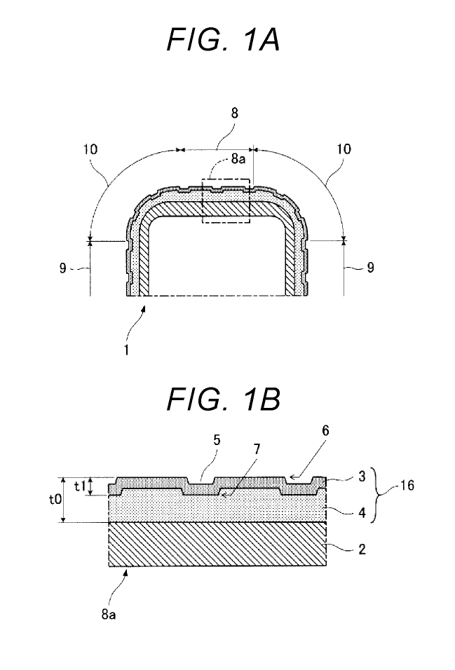

FIGS. 1A and 1B show Embodiment 1 of the present disclosure.

FIG. 1A shows a decorative metal component 1 as a formed article formed by press working such as bending or drawing operation with respect to a metal sheet. An external shape of the decorative metal component 1 has, for example, a top surface part 8, a side surface part 9, and a corner part 10 connecting between the top surface part 8 and the side surface part 9.

A case of the top surface part 8 is cited as an example for explanation, and a layer structure and so on of the decorative metal component 1 in the side surface part 9 and the corner part 10 are the same as in the top surface part 8. FIG. 1B shows an enlarged view of a part 8a of the top surface part 8.

A surface layer 3 for protecting the decorative metal component 1 and an intermediate layer 4 for allowing the metal sheet 2 to closely contact the surface layer 3 are stacked over the metal sheet 2. The surface layer 3 and the intermediate layer 4 are transparent materials transmitting light, and a resin layer 16 including the intermediate layer 4 and the surface layer 3 has a light transmission property. A plurality of concave and convex shapes 5 are formed on an outer surface of the resin layer 16.

According to the above, gloss, hairlines and treatment texture such as vibration polishing on the surface of the metal sheet 2 can be visually recognized and depth feeling is generated due to the concave-convex shapes 5 of the surface layer 3 and the intermediate layer 4, therefore, the design property of the metal formed article is improved.

The material used for the intermediate layer 4 and the surface layer 3 forming the resin layer 16 is not particularly limited as far as it is a thermoplastic material. When a light transmittance is 85% or more, gloss, hairlines and treatment texture such as vibration polishing on the surface of the metal sheet 2 can be visually recognized. The material for the metal sheet 2 is not also particularly limited. The metal sheet 2 may be a substance having metallic luster.

The concave and convex shape 5 is represented by

t0×0.13≤t1<t0×0.85

when a distance between a top 6 of a convex ridge and a bottom surface 7 of a concave trough adjacent to the top 6 is “t1”, and the total thickness of the resin layer 16 is “t0”.

The distance “t1” and the thickness “t0” are the distance and the thickness in a vertical direction on the surface of the metal sheet 2.

The depth feeling on the surface of the decorative metal component 1 can be visually recognized simultaneously with the gloss, hairlines and treatment texture such as vibration polishing on the surface of the metal sheet 2 by reflected light from the surface of the surface layer 3 and light transmitting through the surface layer 3 and the intermediate layer 4 having the light transmission property. A difference in light reflection amount from the surface of the metal sheet 2 occurs between the top 6 of the convex ridge and the bottom surface 7 of the concave trough adjacent in the concave and convex shapes 5, therefore, a shade appears artificially and is recognized as the depth feeling.

However, in a case of t0×0.13>t1, the difference in light reflection amount from the surface of the metal sheet 2 between the top 6 of the ridge and the bottom surface 7 of the trough adjacent in the concave and convex shapes 5 is small and the depth feeling does not appear. In a case of t1≥t0×0.85, the light reflection amount from the surface of the metal sheet 2 in a convex part of the concave and convex shape 5 is extremely low, and it is difficult to visually recognize gloss of the metal sheet 2, therefore, the design property is reduced.

That is, in the state of t0×0.13≤t1<t0×0.85, the decorative metal component 1 with a high design property in which gloss, hairlines, treatment texture such as vibration polishing on the surface of the metal sheet 2 can be visually recognized and the depth feeling is generated due to the concave and convex shapes 5 can be achieved.

Concerning workability in drawing operation, the setting of the thickness in a layer part from the surface of the metal sheet to the top of the trough in the minute concave and convex shape is changed so as to correspond to each shape of drawing, thereby obtaining the decorative metal component while keeping the minute concave and convex shapes as they are without breakage.

### Embodiment 2

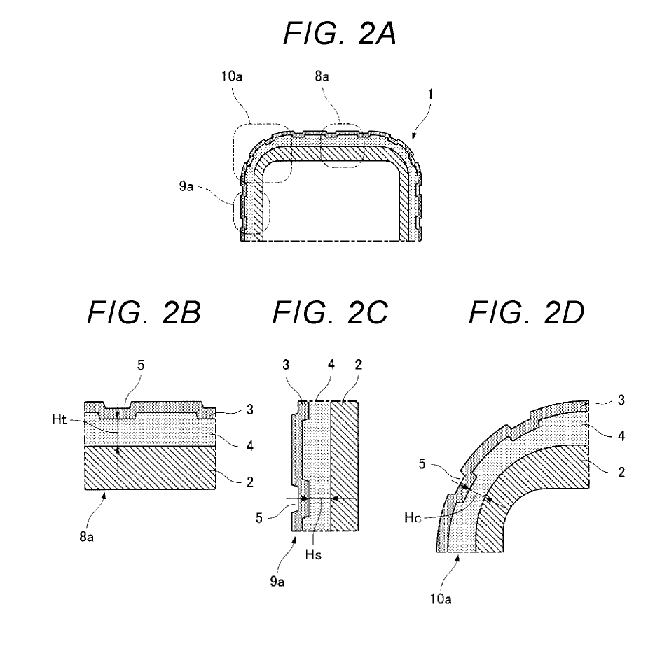

FIGS. 2A, 2B, 2C and 2D show Embodiment 2 of the present disclosure.

In Embodiment 2, the optimum thicknesses in the intermediate layer 4 is defined from the surface of the metal sheet 2 to the bottom surface 7 of the concave trough in the concave and convex shape 5 in respective parts of the top surface part 8, the side surface part 9 and the corner part 10 of the decorative metal component 1.

Enlarged cross-sections of a part 8a of the top surface part 8, a part 9a of the side surface part 9 and a part 10a of the corner part 10 in the decorative metal component 1 shown in FIG. 2A are shown in FIG. 2B, FIG. 2C and FIG. 2D.

In the decorative metal component 1 according to Embodiment 2, “t1” of the concave and convex shape 5 in the top surface part 8, the side surface part 9 and the corner part 10 as well as the total thickness “t0” of the resin layer 16 are set to the optimum values, and when respective thicknesses from the surface of the metal sheet 2 to the bottom surface 7 of the concave-shaped trough described in Embodiment 1 in the top surface part 8, the side surface part 9 and the corner part 10 are Ht, Hs and Hc, the thicknesses have a relation of Ht>Hs>Hc.

Generally, the sheet thickness of the metal sheet 2 is reduced in the side surface part 9 and the corner part 10 when performing press working such as a drawing operation, therefore, the resin layer 16 is also elongated together, which causes collapse and breakage in the concave and convex shapes 5.

In the present embodiment, Ht, Hs and Hc are formed in the same thickness before performing drawing operation, and thicknesses of Hs and Hc are reduced at the time of performing drawing operation. That is, a deformation amount in shape of the concave and convex shape 5 can be reduced by concentrating the deformation in the drawing operation to the intermediate layer 4. The top surface part 8 and the side surface part 9 are both flat surfaces, but a case where the side surface part 9 is elongated by press working and the thickness thereof is reduced to be thinner than that of the top surface part 8 is explained here.

Accordingly, it is possible to visually recognize gloss, hairlines and treatment texture such as vibration polishing on the surface of the metal sheet 2 while keeping the concave and convex shapes 5 as they are without breakage at the time of the drawing operation, and the depth feeling is generated due to the concave and convex shapes 5, therefore, the decorative metal component 1 with a high design property can be obtained.

### Embodiment 3

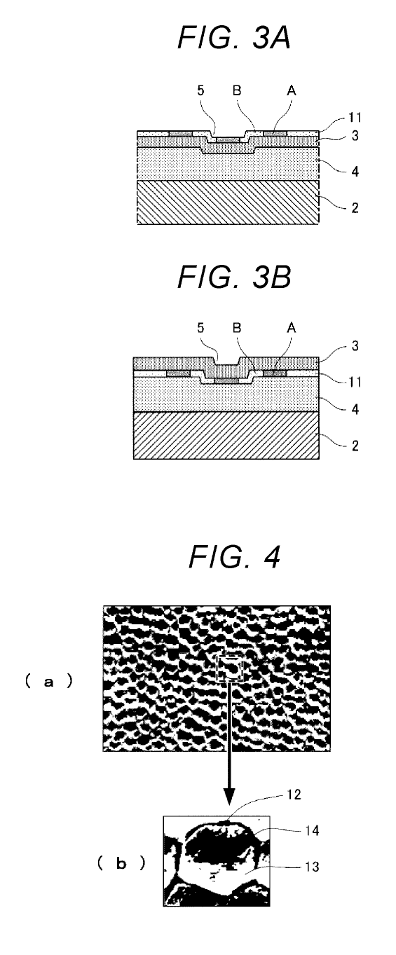

FIGS. 3A, 3B, (a) of FIG. 4 and (b) of FIG. 4 show Embodiment 3 of the present disclosure.

In Embodiment 3, a light absorbing material is contained in part of layers in the resin layer 16 of the decorative metal component 1 according to Embodiment 1 or 2.

Specifically, a light absorbing material layer 11 is formed on an outer surface of the surface layer 3 opposite to the intermediate layer 4, namely, a surface on an elongation following side as shown in FIG. 3A. In a first region A and a second region B adjacent to each other in the light absorbing material layer 11, the first region A has a higher light absorption coefficient than the second region B. Furthermore, the first region A has a lower light transmittance than the second region B.

Accordingly, a light reflection amount from the metal sheet 2 is higher in the first region A than in the second region B and the difference in shade occurs, therefore, concave and convex texture is further emphasized and visually recognized.

Though a region inside the light absorbing material layer 11 is formed by plural regions, visibility of concave and convex texture is particularly good when three regions are provided. For example, in a case where a hammered pattern shown in (a) of FIG. 4 is acquired by a light source inclined by 30 degrees with respect to a vertical direction, three regions of a ridgeline region 12, a metallic luster reflection region 13 and a shaded region 14 are included as in an enlarged view shown in (b) of FIG. 4. (a) of FIG. 4 is a view obtained by imaging a range of 6 cm.×4 cm, and (b) of FIG. 4 is a view obtained by enlarging part of (a) of FIG. 4 approximately six times.

When the light absorption coefficient in the ridgeline region 12 is Lr, the light absorption coefficient in the metal luster reflection region 13 is Lm, and the light absorption coefficient in the shaded region 14 is Ls,

the light absorbing material is contained so that

Lm<Lr<Ls, thereby reproducing concave and convex texture of the hammered pattern by visual recognition.

A printing method of the light absorbing material layer 11 is not particularly limited, and for example, gravure printing, screen printing, ink-jet printing and so on can be cited.

According to the above, it is possible to visually recognize gloss, hairlines and treatment texture such as vibration polishing on the surface of the metal sheet 2 and the depth feeling is generated due to the concave and convex shapes 5, therefore, the decorative metal component 1 with a high design property can be obtained.

Though the light absorbing material layer 11 is provided on the outer surface of the surface layer 3 in FIG. 3A, the same effects can be expected when adopting a layer structure in which the light absorbing material layer 11 is provided between the surface layer 3 and the intermediate layer 4 as shown in FIG. 3B.

### Embodiment 4

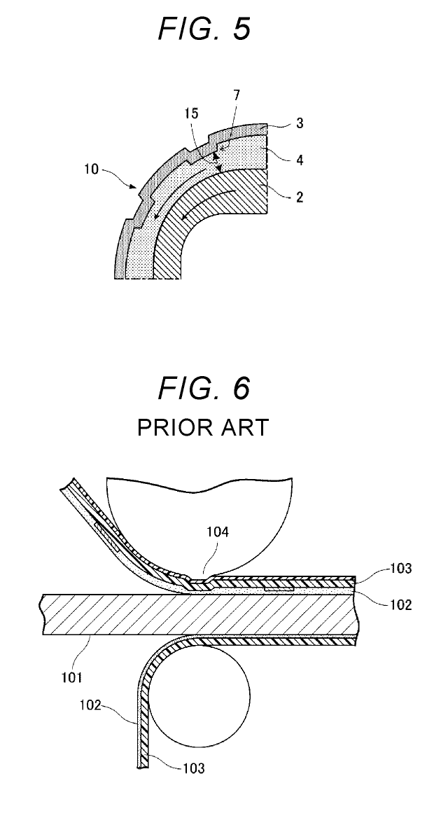

FIG. 5 shows Embodiment 4 of the present disclosure.

In Embodiment 4, a processing method of press working with respect to the decorative metal component 1 according to Embodiment 1 or 2 will be explained. The processing method of press working with respect to the decorative metal component 1 according to Embodiment 3 is also the same.

The intermediate layer 4 of the decorative metal component 1 explained in Embodiment 1 or 2 is formed of a thermoplastic resin, which is softened by being heated. In the processing method according to Embodiment 4, only an inner peripheral part 15 from the surface of the metal sheet 2 to the bottom surface 7 of the trough in the concave and convex shape 5 is heated to a softening temperature of the intermediate layer 4 before starting press working such as bending or drawing operation with respect to the metal sheet, then, drawing operation is performed, as a result, the inner peripheral part 15 from the surface of the metal sheet to the bottom surface of the concave trough follows the elongation of the metal sheet 2 as shown in FIG. 5.

When only the inner peripheral part 15 is heated, the shape of the surface layer 3 can be kept. If the entire intermediate layer 4 is heated, the shape of the surface layer 3 is collapsed due to heat. The heating temperature of the intermediated layer 4 at that time is, for example, 40° C. to 70° C., which differs according to, for example, the material. The surface layer 3 is not softened at 40° C. to 70° C.

Accordingly, a thickness of only the inner peripheral part 15 from the surface of the metal sheet to the bottom surface of the concave trough is reduced, and the concave and convex part in which drawing operation is performed at a temperature lower than the softening temperature of the intermediate layer 4 can be formed almost without generating collapse in shape such as reduction in thickness.

The heating of the inner peripheral part 15 is more effective when heating is performed from a back surface 2a of the metal sheet 2 with high thermal conductivity on the side where the intermediate layer 4 is not provided, and the metal sheet 2 may be heated by heater heating, hot water heating and the like with a heating source, or electromagnetic heating, electrical heating and the like which are self-heating.

According to the above, it is possible to visually recognize gloss, hairlines and treatment texture such as vibration polishing on the surface of the metal sheet 2 and the depth feeling is generated due to the concave and convex shapes 5, therefore, the decorative metal component 1 with a high design property according to Embodiments 1 to 3 can be obtained.

In the decorative metal component according to the present disclosure, it is possible to acquire a formed article with no failure in concave and convex shapes in bending or drawing operation while increasing the design property by glossy feeling originally possessed by the metal and expression of the depth feeling due to the concave and convex shapes, therefore, the present disclosure can be applied to various appearance press-formed articles such as home electric appliances such as a refrigerator, a washing machine and a microwave, and in-vehicle interior parts.

What is claimed is:

1. A decorative metal component that is a formed article formed by press working such as a bending or drawing operation with respect to a metal sheet, comprising:
a resin layer with concave and convex shapes laminated on one surface of the metal sheet,
wherein the resin layer has a light transmission property,
the resin layer includes a surface layer and an intermediate layer bonding the metal sheet to the surface layer,
the intermediate layer is a thermoplastic resin, and
when a distance in a vertical direction between a top of a convex ridge and a bottom surface of a concave trough adjacent in the concave and convex shapes is “t1”, and the total thickness of the resin layer is “t0”,
t0×0.13≤t1<t0×0.85.

2. The decorative metal component according to claim 1,
wherein an external shape has a top surface part, a side surface part and a corner part connecting between the top surface part and the side surface part, and
when a thickness from the surface of the metal sheet to the bottom surface of the trough of the concave and convex shape in the intermediate layer in the top surface part is Ht,
a thickness from the surface of the metal sheet to the bottom surface of the trough of the concave and convex shape in the intermediate layer in the side surface part is Hs, and
a thickness from the surface of the metal sheet to the bottom surface of the trough of the concave and convex shape in the intermediate layer in the corner part is Hc,
the thicknesses have a relation of Ht>Hs>Hc.

3. The decorative metal component according to claim 2,
wherein a light absorbing material is contained in a part of layers of the resin layer,
the light absorbing material has a light transmission property, and
in a first region and a second region adjacent to each other in the light absorbing material layer, the first region has a higher light absorption coefficient and a lower light transmittance than the second region.

4. A processing method for a decorative metal component used when pressing a material including a resin layer with concave and convex shapes laminated on one surface of the metal sheet, in which the resin layer has a light transmission property, the resin layer is formed of a surface layer and an intermediate layer bonding the metal sheet to the surface layer, the intermediate layer is a thermoplastic resin, and when a distance in a vertical direction between a top of a convex ridge and a bottom surface of a concave trough adjacent in the concave and convex shapes is “t1”, and the total thickness of the resin layer is “t0”, t0×0.13≤t1<t0×0.85, the method comprising:
heating apart from the surface of the metal sheet to the bottom surface of the trough of the concave and convex shapes to be higher than a softening temperature of the intermediate layer before press working to thereby allow the part from the surface of the metal sheet to the bottom surface of the trough in the intermediate layer to follow an elongation of the metal sheet.
